(19) United States
(12) Patent Application Publication
(10) Pub. No.: US 2021/0070606 A1
(43) Pub. Date: Mar. 11, 2021

(54) SLEEP PRODUCTS HAVING GEL LAYERS AND METHODS OF MAKING SLEEP PRODUCTS HAVING GEL LAYERS

(71) Applicant: Comfort Revolution, LLC, West Long Branch, NJ (US)

(72) Inventors: Dimitrios S. Corodemus, West Long Branch, NJ (US); Brian Bryant, West Long Branch, NJ (US); David Harris, West Long Branch, NJ (US); Tim Fitzgerald, West Long Branch, NJ (US)

(21) Appl. No.: 16/967,083

(22) PCT Filed: Feb. 2, 2019
(86) PCT No.: PCT/US2019/016437

§ 371 Date: Aug. 3, 2020

Related U.S. Application Data
(60) Provisional application No. 62/626,556, filed on Feb. 5, 2018.

(51) Int. Cl. B68G 7/00; A47C 27/08; B68G 5/00; A47C 27/15

(52) U.S. Cl. CPC B68G 7/00; A47C 27/085; A47C 27/15; B68G 5/00; A47C 27/088

(57) ABSTRACT

The methods and structures disclosed herein may be used to make sleep products having foam substrates and gel layers such as mattresses, mattress toppers and pillows. The gel layers may have cooling properties and may include phase change materials. The foam substrates may also be treated with phase change materials.

### CLAIM TO PRIORITY

This 35 U.S.C. § 371 National Stage Patent Application claims priority to PCT Patent Application No. PCT/US2019/016437, filed Feb. 2, 2019, and titled “Sleep Products Having Gel Layers and Methods of Making Sleep Products Having Gel Layers” which claims priority to and benefit of U.S. Provisional Patent Application Ser. No. 62/626,556, filed Feb. 5, 2018, and titled “Sleep Products Having Gel Layers and Methods of Making Sleep Products Having Gel Layers”, all of which is incorporated by reference herein.

### BACKGROUND OF THE INVENTION

### Field of the Invention

The present patent application is generally related to sleep products, and is more specifically related to sleep products such as mattresses, mattress toppers and pillows having cooling gel layers incorporated therein.

### Description of the Related Art

There have been many developments related to sleep products having gel layers incorporated therein.

In spite of the above advances, there is a continuing need for sleep products having foam substrates and having cooling gel layers incorporated into the foam substrates.

The information included in this Background section of the specification, including any references cited herein and any description or discussion thereof, is included for technical reference purposes only and is not to be regarded subject matter by which the scope of the invention is to be bound.

### SUMMARY OF THE INVENTION

The present application discloses one or more of the features recited in the appended claims and/or the following features which alone or in any combination, may comprise patentable subject matter.

The methods and structures disclosed herein may be used to make sleep products having foam substrates and gel layers such as mattresses, mattress toppers and pillows. The gel layers may have cooling properties and may include phase change materials. The foam substrates may also be treated with phase change materials.

These and other embodiments of the present invention will be described in more detail below.

According to some embodiments, a method of forming a support cushion may comprise providing a flexible foam layer, forming a window in the upper surface of the foam layer, disposing a curable gel within the window of the foam layer, and, forming a continuous top surface with the curable gel and the upper surface of the foam layer.

In some optional embodiments, the following optional features may be used with the method either alone or in combination with one another and the method. The method may provide that the flexible foam layer may be a plurality of foam layers. The method may further provide a dam about the plurality of foam layers, wherein the dam extends above the plurality of foam layers. The method may further comprise aligning peripheral edges of the plurality of layers of foam. In some embodiments, the foam layer may be a single piece of foam. In some embodiments, the foam layer may be a plurality of foam layers. In such multi-layer embodiments, the upper layer of foam of the plurality of foam layers with a plurality of slats and defining the window therebetween. The method may alternatively comprise forming a layer beneath an upper layer with the window and the curable gel. In some embodiments, the flexible foam layer may comprise a viscoelastic foam.

According to some embodiments, a method of forming a support cushion may comprise providing a mold wall, providing at least one piece of foam within the mold wall, disposing a curable gel within the mold and on an upper surface of the at least one piece of foam, aligning, with the mold wall, peripheral edges of the at least one piece of foam and the curable gel.

According to some optional embodiments, the following optional features may be used with the method either alone or in combination with one another and the method. The method may further comprise defining an upper surface of the support cushion with the curable gel. The method may further comprise defining an upper surface of the support cushion with the curable gel and the at least one piece of foam. The method may further comprise forming the at least one piece of foam of a plurality of layers of foam. The method may further comprise forming the curable gel at one of the plurality of layers below an upper layer.

According to some embodiments, a support cushion may comprise at least one first foam portion, a gel disposed on an upper surface of the at least one first foam portion, the gel defining at least a portion of an upper surface of the support cushion.

In some optional embodiments, the following optional features may be used with the cushion either alone or in combination with one another and the cushion. The at least one first foam portion may define a window. The gel and the upper surface of the at least one first foam portion may define a continuous surface. The gel may define an entirety of the upper surface of the support cushion. In some embodiments, the at least one first foam portion may be a memory foam. The at least one first foam portion may be a plurality of layers of foam. The upper surface of the at least one first foam portion being a plurality of slats that define a window.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

In order that the embodiments may be better understood, embodiments of a sleep product having a gel layer will now be described by way of examples. These embodiments are not to limit the scope of the claims as other embodiments of a sleep product having a gel layer will become apparent to one having ordinary skill in the art upon reading the instant description. Non-limiting examples of the present embodiments are shown in figures wherein:

FIGS. 1A-1C show a method of making a sleep product having a foam substrate and a gel layer, in accordance with one embodiment of the present patent application;

FIGS. 2 and 3 show a method of making a sleep product having a foam substrate and a gel layer, in accordance with one embodiment of the present patent application;

FIGS. 4A-4D show a method of making a sleep product having a foam substrate and a gel layer, in accordance with one embodiment of the present patent application;

FIGS. 5A-5C show a method of making a sleep product having a foam substrate and a gel layer, in accordance with one embodiment of the present patent application;

FIGS. 6A-6C show various illustrative configurations of gel layer locations relative to the foam layers; and,

FIGS. 7A-7C show various illustrative configurations of gel layers within a foam layer.

### DETAILED DESCRIPTION OF PREFERRED EMBODIMENTS

It is to be understood that a sleep product having a gel layer is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

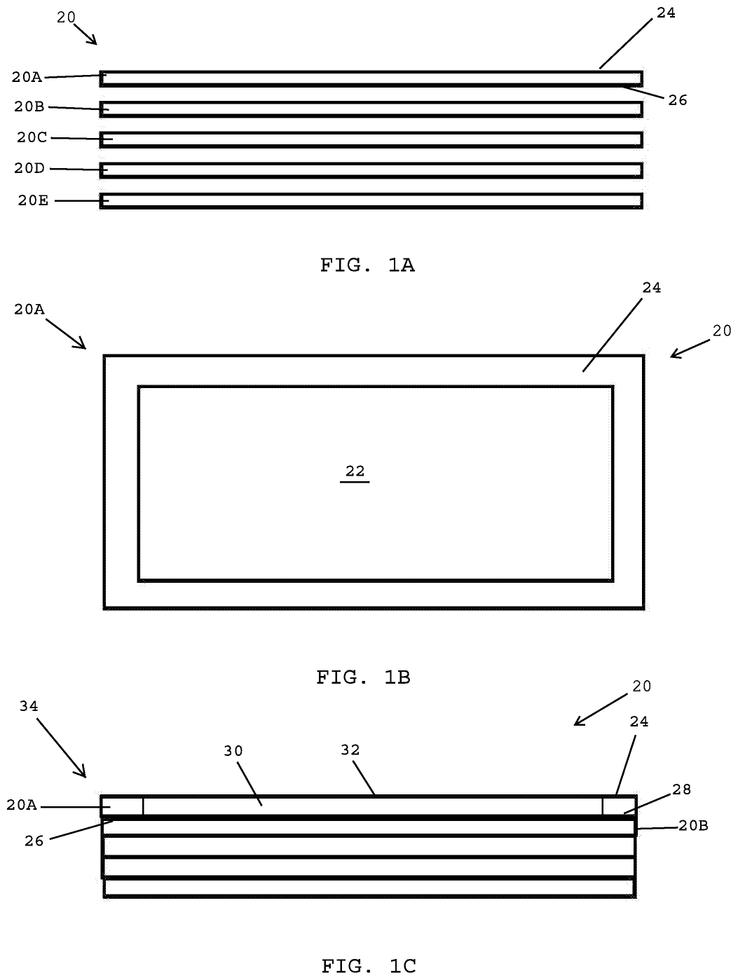

With reference to FIG. 1-7C, the methods and structures disclosed herein may be used to make sleep products having foam substrates and gel layers such as mattresses, mattress toppers and pillows. The gel layers may have cooling properties and may include phase change materials. The foam substrates may also be treated with phase change materials. A method and structure for a sleeping product such as a body support cushion is provided.

Referring now to FIG. 1A, in one embodiment, a method of making a mattress or other sleeping product 20 includes providing foam layers 20A-20E. The foam layers may comprise various types of foams and in some embodiments comprise at least one layer of memory foam. Such flexible foams include, but are not limited to, latex foam, reticulated or non-reticulated visco-elastic foam (sometimes referred to as memory foam or low-resilience foam), reticulated or non-reticulated non-visco-elastic foam, polyurethane high-resilience foam, expanded polymer foams (e.g., expanded ethylene vinyl acetate, polypropylene, polystyrene, or polyethylene), and the like. In one embodiment, the foam layers 20A-20E have the same size, dimension and shape and are adapted to be stacked atop one another to form sleep products such as a sleeping mattress. In other embodiments, foam layers may have different sizes and dimensions and may be used for making pillows or mattress toppers. Various sizes, shapes and thicknesses of foam may be used and various numbers of layers may be utilized in accordance with this disclosure.

In some embodiments, the lowest or lower plurality of layers may be referred to in some constructions as a core or support, layer or layers. One or more layers above the core or support, layer or layers may be referred to as support layer(s). As used herein, the terms “upper layer”, “upper layers”, “comfort layers” and “top layer” and “topper” all refer to and mean the one or more layers of a foam mattress construction which are located in an upper or uppermost region of the mattress, proximate to or forming the support surface of the mattress, and supported by one or more intermediate layers and a one or more base layers or core layers, which generally has an aggregate thickness dimension greater than a thickness dimension of the upper layers.

Referring to FIGS. 1A and 1B, in one embodiment of the sleep product 20, the top foam layer 20A is treated to remove material from a central region of the top foam layer to define a window 22 that extends from a top surface 24 to a bottom surface 26 of the top foam layer 20A. In one embodiment, more than one of the foam layers may have a window formed therein.

Referring to FIGS. 1A-1C, in one embodiment of the sleep product 20, the bottom surface 26 of the top foam layer 20A is secured over a top surface 28 of a second foam layer 20B, which lies beneath the top foam layer 20A. After the top foam layer 20A has been assembled over the second foam layer 20B, the top surface 28 of the second foam layer 20B is accessible through the window 22 formed in the top foam layer 20A.

Referring to FIG. 1C, in one embodiment of the sleep product 20, a curable gel material 30 may be disposed (e.g., poured, deposited, sprayed) within the window 22 (FIG. 1B) formed in the top foam layer 20A. The curable gel material 30 is preferably cured to form a cured gel layer at the top surface of the mattress. In one embodiment, the cured gel layer 30 has a top surface 32 that lies in the same plane as the top surface 24 of the top foam layer 20A to define a continuous layer that extends over the top of the mattress 34. Further, it should be understood that the gel may have a continuous, smooth surface or may have a patterned or randomly shaped surface. Either of these surfaces may be exposed to the outer surface of the cushion (i.e. face up or face down), and further, as will be described further, the gel layer, also referred to as gel inlay, is not limited to the top most layer but may also be defined in layers below the upper layer.

In some embodiments, the gel may be, for non-limiting example, a polyurethane gel or polyether gel. The gel layer may be sprayed or poured onto the foam and cured in position, or poured separately to a desired dimension, cured and later applied in the desired opening of the foam. In any of these embodiments, the gel cures to become the gel layer of the body support cushion or sleeping product.

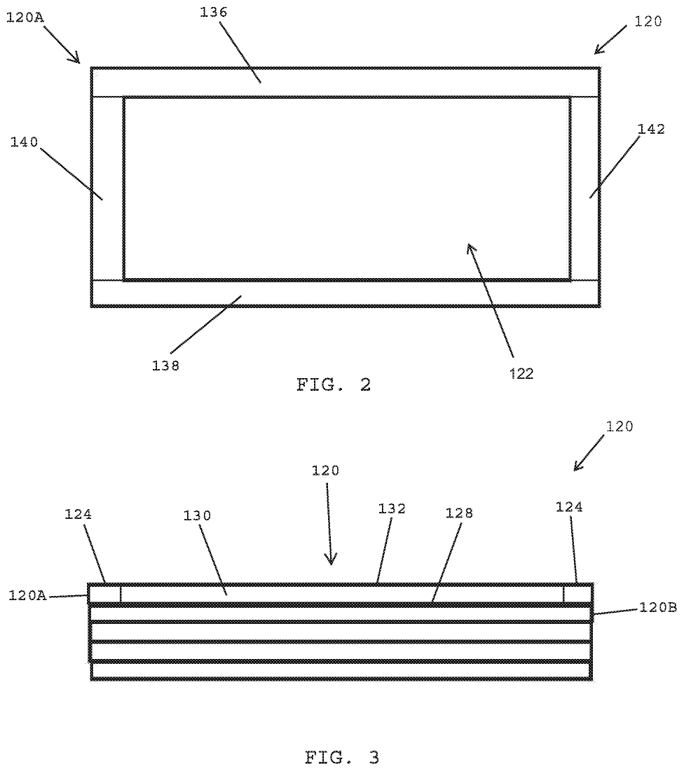

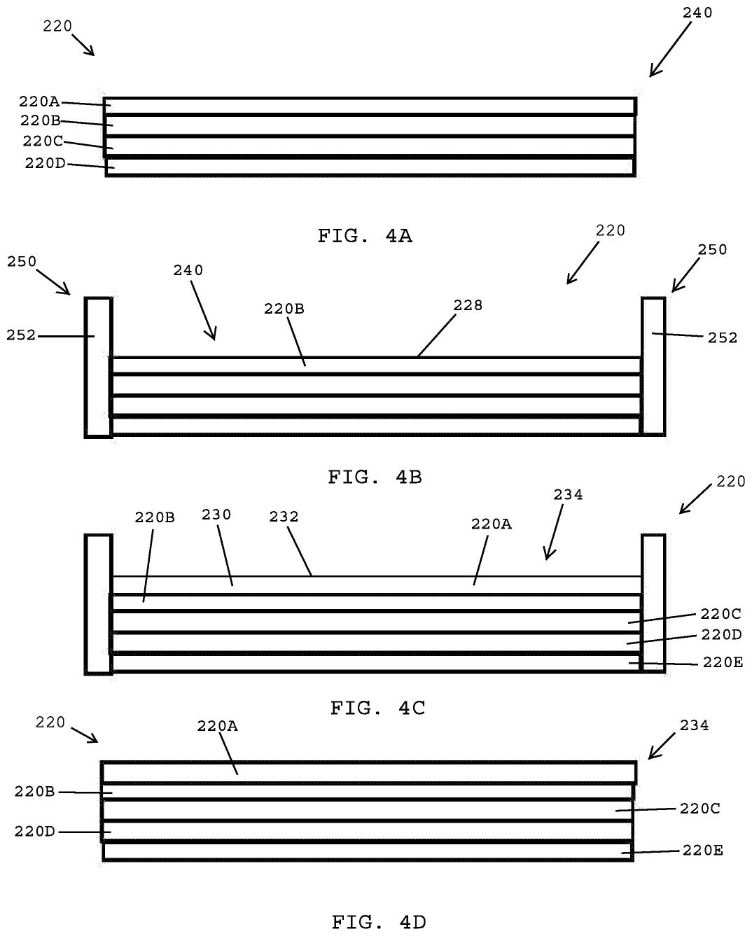

Referring to FIGS. 2 and 3, in one embodiment of the sleep product 120, the borders of a top foam layer 120A and a window 122 in the top foam layer 120A may be formed by securing slats 136, 138, 140, and 142 of foam material to the top surface 128 of an underlying foam layer 120B. The slats may also be referred to as rails or strips of foam. The slats of material 136, 138, 140, and 142 form a dam atop the underlying foam layer 120B, whereby the window 122 is defined by the slats. A curable gel material 130 is disposed within the window 122. The gel material 130 may be cured as described above to form a cured gel layer at the top surface of the mattress. The cured gel layer 130 preferably has a top surface 132 that lies in a common plane with the top surfaces 124 of the slats 136, 138, 140, and 142 that surround the cured gel layer 130.

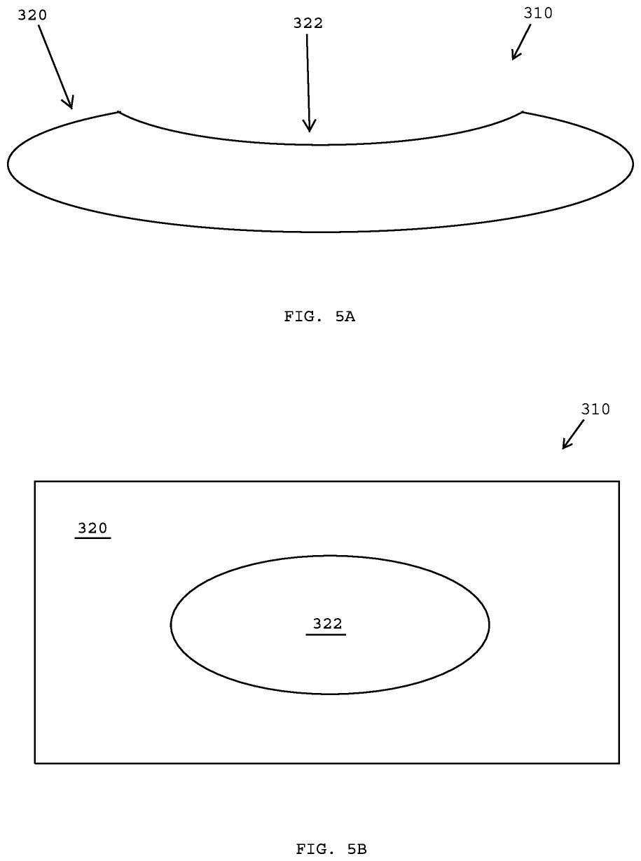

Referring to FIG. 4A, in one embodiment of the sleep product 220, a method of making a mattress includes providing foam layers 220A-220D. The foam layers may include memory foam or any of the previously noted foam types. In one embodiment, the foam layers 220A-220D have the same size, dimension and shape and are adapted to be stacked atop one another to form a mattress subassembly 240.

Referring to FIGS. 4A and 4B, in one embodiment of the sleep product 220, a method includes providing a mold 250 having side walls 252 that surround the sides of the mattress subassembly 240. The side walls 252 of the mold 250 may extend above the top surface 228 of the foam layer 220B to define a dam that surrounds the foam layer 220B.

Referring to FIG. 4C, with the mold 250 in place, a curable gel material 230 is disposed over the foam layer 220B to form a top layer 220A of curable gel material 230. As in previous embodiments, the gel may be cured to form a cured gel layer 220A having a top surface 232 that defines a top surface of a mattress 234. In one embodiment, the cured gel layer 230 is aligned with the outer perimeter of the underlying foam layers 220B-220E.

Referring to FIG. 4D, in one embodiment of the sleep product 220, after the gel layer is cured, the mold 250 (FIG. 4C) is removed and the cured gel layer 230 remains in place to form a top gel layer 220A of the mattress 234. In one embodiment, the top gel layer 220A lies above underlying foam layers 220B-220E. Accordingly, the gel layer 220A may extend to the edge of the sleeping product.

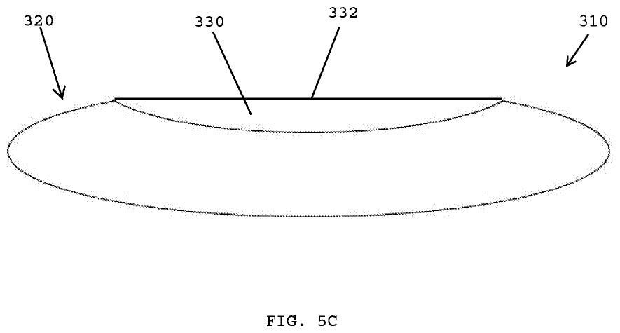

Referring to FIGS. 5A-5C, in one embodiment of the sleep product 310, a block of foam 320 is formed to provide a foam substrate. The foam may be memory foam and/or others. A portion of the foam material may be removed from the foam substrate to form a depression 322 in the foam substrate. A curable gel material 330 may be deposited into the depression. The curable gel material may be cured to provide a cured gel layer 330 having a top surface 332. The cured gel layer 330 may have an exposed surface that is aligned with an outer surface of the foam substrate to form a gel layer that is exposed at the outer surface of the foam substrate. The foam substrate may be in the shape of a mattress, a mattress topper, or a pillow.

In one embodiment, the foam substrate may be molded within the depression formed in a surface of the foam substrate so that foam material does not have to be removed from the foam substrate to form the depression. The curable gel material may then be deposited into the depression and cured to form a cured gel layer exposed at an outer surface of the foam substrate.

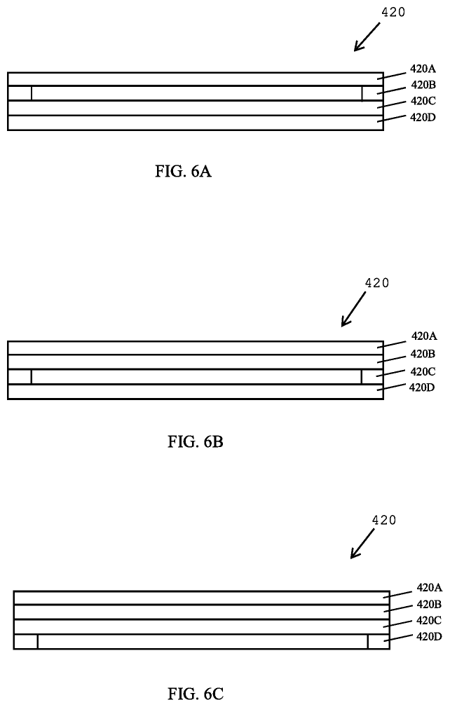

In some embodiments, the instant body support cushion or sleeping product may provide that one or more gel layers are provided at a level below the upper most level of the cushion. With reference to FIGS. 6A-6B, different embodiments of a sleep product or body support cushion 420, for non-limiting example, a mattress are provided. The body support cushion 420 is provided in the embodiments with differing numbers of layers merely for purpose of showing that the support cushion is not limited to a single number of layers.

With reference to FIG. 6A, the support cushion 420 is shown having four layers 420A, 420B, 420C, and 420D. The instant embodiment provides the gel layer is provided within the second layer 420B rather than the upper layer as in previous embodiments. Further, the instant embodiment provides that the second layer 420B may be formed in a variety of manners. The layer 420B may be formed of two or more rails or slats to define the open area wherein the gel layer or layers may be deposited. Alternatively, the foam layer 420A may be formed of a single piece of foam which is cut out to remove material or the internal material is otherwise removed to define the boundary for depositing of the gel to form and cure. The gel layer (within the foam layer 420B) may be formed in a variety of ways.

With reference to FIG. 6B, the gel layer is moved into the third foam layer 420C, as represented by the slots, rails, or strips of foam. In this arrangement, the gel is located in a lower elevation of the support cushion 420 than in FIG. 6A and the previous embodiments. Further, the foam layer 420C in any of the various manners previously described, for non-limiting example plurality of foam strips, rails or slats, or alternatively a layer of foam with a removed portion that may be filled with the gel layer.

With further reference to FIG. 6C, a further embodiment of the body support cushion 420 is provided in further distinction of FIGS. 6A and 6B. The instant embodiment provides that the gel layer is disposed for curing at the layer 420D, the lowermost layer of the body support cushion 420. As in the previous embodiments, the layer of foam 420D may be provided by strips, rails or slats to define a boundary for the gel layer. Further, the foam layer 420D may also be formed as a single piece of foam which has a portion removed to receive the gel layer.

With regard to any of the embodiments shown in FIG. 6, an alternate embodiment or manufacturing may be provided wherein a wall structure is used, as in FIGS. 4A-D, which allows for the gel layer to extend to the edge of the support cushion.

In some embodiments, a sleeping product may have two or more gel layers exposed at an outer surface and outer layer of a foam substrate or disposed within any one or more layers below the top layer. This may be dependent upon the desired feel of the bed. If the gel layer(s) is disposed near the upper surface/layer, the bed will feel firmer. If the gel layer is disposed in a lower layer, closer to the bottom layer, the bed will have more support. This results in a more supported feel and less sinking into the mattress, for example.

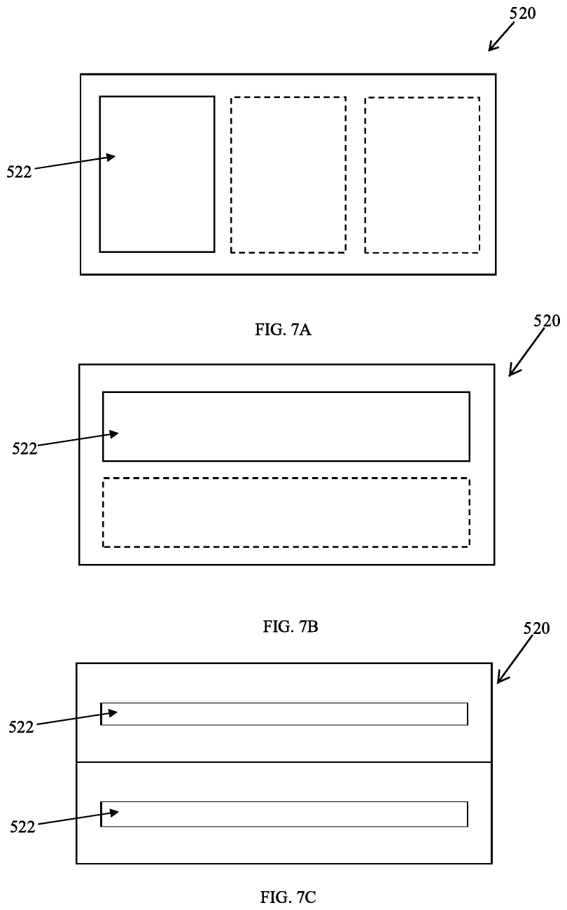

With reference now to FIGS. 7A-7C, a further embodiment of the body support cushion 520 is provided. In previous embodiments, the gel layers have extended about nearly the entire surface area of any layer of the body support cushion. In the instant embodiments, it is provided that the gel layer, which may be in the upper layer or any of the layers below, may be used in one or more sections to vary the feeling of a specific area of the support cushion 520. As shown in FIG. 7A, the gel layer 522 may be at an end of the bed, for example the head end to provide a desired feeling in that location. Still further however, according to some embodiments, optional locations are shown in broken line.

Referring now to FIG. 7B, an embodiment of the support cushion 520 is shown wherein the gel layer 522 is shown extending in a longitudinal direction (head to toe) of the bed. The gel layer 522 may be in the upper layer of the foam or may be formed in any of the various lower layers. Further, a broken line is depicted showing an optional location for a second gel layer, according to this embodiment. As one of skill in the art should understand, the gel layers may be disposed in various locations and have various sizes, and be disposed at various depths. Further, the two gel layers depicted may be used together and have same or differing characteristics to provide two differing feels to the user. Moreover, the gel layers may be in the same or differing layers of foam.

Referring now to FIG. 7C, an embodiment of the support cushion 520 is also shown wherein the gel layer is changed dimensionally. The support cushion 520 may be defined by two or more pieces of foam to define the upper layer. Further, in this embodiment, there may be one or more gel layers in each piece of foam and in the instant depiction there are shown two gel layers extending in the head to toe direction of the cushion (for example of a mattress), one gel layer in each piece of foam. The gel layers may be dimensioned to have a smaller width (in the side to side direction of the illustrative mattress) but this is merely illustrative as one of various possibilities. The embodiment provides that the gel layers may have surface areas which are sized to be substantially most of the surface area of the cushion, or may be sized to be substantially less of the surface area of the piece of foam or the cushion 520 as a whole.

Reference is now turned to Table 1, herein, which provides various measurements for pressure points on the bed and a value related to support for each of four tested mattresses. This is also sometimes referred to as pressure mapping. With regard to the pressure value, the smaller the value the better the resultant feeling or lack of pressure points to the users. Alternatively, with regard to the support values, the larger the value the better the support provide to the user. The tests were run for a man and woman with body characteristics provided in the table.

The beds tested also varied in arrangement of rails or slats, size of gel inlay, or location (layer) of gel and height of visco. In the instant embodiments, bed one was sized with six inches (6″) top and side rails, as well as a forty-four inches (44″) gel inlay on a top layer of the support cushion. Bed two was sized with a twenty-six inches (26″) top rail, six inches (6″) side rails and a forty-four inches (44″) gel inlay also on the top surface of the body support cushion. Bed three was sized with six inches (6″) top and side rails, a full mattress gel inlay as a second layer. The top layer of the body support cushion was one-half (½″) visco top layer. Bed four was a six inches (6″) top and side rails with a full mattress gel inlay as a second layer, from the top. The top layer was a one-inch (1″) visco top layer. The table of results of these four examples is as follows:

TABLE 1

| | Bed 1 Peak | Bed 1 | Bed 2 Peak | Bed 2 | Bed 3 Peak | Bed 3 | Bed 4 Peak | Bed 4 |
|---|---|---|---|---|---|---|---|---|
| | Pressure | Support | Pressure | Support | Pressure | Support | Pressure | Support |
| Man | 40.38 | 5584.7 | 39.03 | 5887.1 | 37.15 | 5846.8 | 40.26 | 5846.8 |
| Woman | 34.05 | 3820.6 | 32.51 | 3810.5 | 32.56 | 4344.7 | 35.88 | 4243.9 |

| Test Subjects | Height | Weight |
|---|---|---|
| Man | 6′2″ | 220 lbs |
| Woman | 5′5″ | 120 lbs |

As may be discerned from the test results, the bed support and nearly highest for bed three for the man and highest for the woman. Additionally, the pressure value is the lowest for bed three for the man and nearly lowest for the woman, meaning bed three has the best combined result for both reducing pressure points and improving support of the mattress. The pressure mapping test shows that with more mass of the user, the distribution of weight improves and reduces the number of pressure points felt by the user.

Further, as with any foam mattress that is shipped or packaged, many cushions must be compressible for shipment and then must be able to expand to original size within an acceptable size. Various embodiments have been tested with gel layers and determined that the gel layer does not appreciably inhibit the expansion or recovery of the body support cushions of the instant embodiments.

In one embodiment, the sleep products disclosed herein may be manufactured and the foam substrates disclosed herein may be treated with a cooling gel as disclosed in commonly assigned U.S. patent application Ser. No. 15/186,781, filed Jun. 20, 2016, the disclosure of which is hereby incorporated by reference herein.

In some embodiments of a body support cushion, for example a foam mattress constructed with engineered foams, the body support cushion may also include phase change material (PCM) on an uppermost or top layer which may be referred to as “PCM coated layer” and/or “top layer of foam”. Further in some embodiments at least one layer of foam may also have a convoluted surface, i.e. non-planar which is oriented downward to face the underlying layers of the cushion or upward to face the overlying layer. However, the disclosure also includes top layers, and other layers which are planar on both sides. On a top surface of the top layer, an area may be a prescribed area in which a PCM is applied by sprayed, rolled or other mode of application as a relatively thin layer or coating, referred to generally herein as “PCM coating”. Further, the PCM may also be used with or disposed on the gel and therefore aid in heat removal from a user of the body support cushion.

In some embodiments, the PCM may also be complemented by other materials or alternatively other materials may be utilized without the PCM. For example, as one skilled in the art will understand, materials that are able to conduct heat away from the user are desirable due to the perception that some foam types “sleep hot”. Accordingly, other materials which may be utilized in the foam include, but are not limited to, copper and ceramic.

Another material which may be utilized includes charcoal which aids in absorbing smells which may be from the user or from the cushion materials. The charcoal may also be used with carbon and/or graphite all of which may additionally provide microbial benefits.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A method of forming a support cushion, comprising:
providing a flexible foam layer;
forming a window in an upper surface of the foam layer;
disposing a curable gel within the window of the foam layer; and,
forming a continuous top surface with the curable gel and the upper surface of the foam layer.

2. The method of claim 21, providing a dam about said plurality of foam layers, wherein said dam extends above said plurality of foam layers.

3. The method of claim 2 further comprising aligning peripheral edges of said plurality of layers of foam.

4. The method of claim 1 wherein said foam layer is a single piece of foam.

5. The method of claim 1 wherein said foam layer is a plurality of foam layers.

6. The method of claim 5 forming an upper layer of foam of said plurality of foam layers with a plurality of slats and defining said window therebetween.

7. The method of claim 5 forming a layer beneath an upper layer with said window and said curable gel.

8. The method of claim 1 wherein said flexible foam layer comprises a viscoelastic foam.

9. A method of forming a support cushion, comprising:
providing a mold wall;
providing at least one piece of foam within the mold wall;
disposing a curable gel within the mold and on an upper surface of the at least one piece of foam;
aligning, with said mold wall, peripheral edges of the at least one piece of foam and the curable gel.

10. The method of claim 9, further comprising defining an upper surface of said support cushion with said curable gel.

11. The method of claim 9, further comprising defining an upper surface of said support cushion with said curable gel and said at least one piece of foam.

12. The method of claim 9 further comprising forming said at least one piece of foam of a plurality of layers of foam.

13. The method of claim 12 further comprising forming said curable gel at one of said plurality of layers below an upper layer.

14. A support cushion, comprising:
at least one first foam portion;
a gel disposed on an upper surface of said at least one first foam portion;
said gel defining at least a portion of an upper surface of said support cushion.

15. The support cushion of claim 14, said at least one first foam portion defining a window.

16. The support cushion of claim 15, said gel and said upper surface of said at least one first foam portion defining a continuous surface.

17. The support cushion of claim 14, said gel defining an entirety of the upper surface of said support cushion.

18. The support cushion of claim 14, said at least one first foam portion being a memory foam.

19. The support cushion of claim 14, said at least one first foam portion being a plurality of layers of foam.

20. The support cushion of claim 19, said upper surface of said at least one first foam portion being a plurality of slats that define a window.

21. The method of claim 1, wherein said flexible foam layer is a plurality of layers of foam.
